(19) United States
(12) Patent Application Publication
(10) Pub. No.: US 2008/0315573 A1
(43) Pub. Date: Dec. 25, 2008

(54) Book attachment for interactive reading

(76) Inventors: Ingrid Crepeau, Silver Spring, MD (US); Michele Valeri, Silver Spring, MD (US)

Correspondence Address: PATTON BOGGS LLP, 8484 WESTPARK DRIVE, SUITE 900, MCLEAN, VA, 22102, US

(21) Appl. No.: 11/819,121

(22) Filed: Jun. 25, 2007

(51) Int. Cl. B42D 3/00

(52) U.S. Cl. 281/17; 281/19.2; 434/178

(57) ABSTRACT

An attachment for a standard book may allow a reader to read to a group of listeners with reduced movements of the standard book. The attachment may slide over and couple to a cover of a standard book The attachment may have pockets or other attachment means that are coupled to the front and/or back cover of the book The pages of the attachment may have text and/or illustrations that substantially correspond to the text and/or illustrations found in the standard book The pages of the attachment may be connected to the attachment means with a spiral or other type of binding. The reader preferably flips pages in the attachment such that the pages in the attachment correspond to pages in the book that are being read. A method of interactive reading can use interactive prompts, suggested activities, and/or additional text for encouraging the reader to involve the listeners.

### FIELD OF THE INVENTION

The invention relates generally to an apparatus and method for reading aloud to one or more listeners, and, more particularly, to an attachment for a standard book and method of interactive reading to allow a reader engage the one or more listeners in the reading process.

### BACKGROUND OF THE INVENTION

Reading to one or more listeners is an important undertaking for both entertainment and education purposes. Furthering development of the one or more listeners is particularly important during the reading process. While merely reading to the one or more listeners is a valuable activity, it is also imperative that the reader involve the one or more listeners in the reading process. Involving the one or more listeners in the reading process allows the one or more listeners to gain greater benefits from the reading process, such as a deeper understanding of the materials being read, than passive listening alone.

Standard books are generally intended to be read alone by one reader. Using standard books, a reader generally starts with the book in front of the reader, with the front cover facing the reader. The reader then proceeds to read the pages of the standard book sequentially, flipping through sequential pages and reading the text and viewing the illustrations on those sequential pages.

Alternatively, standard books may be read aloud by one reader to one listener or a small group of listeners that sit next to the reader. As in the case of a solo reader, the pages of the standard book are read aloud sequentially, flipping through the sequential pages and reading the text and showing the illustrations on those sequential pages. This process works well when the reader is reading aloud to one or two listeners that are able to sit next to the reader and directly observe the pages of the standard book from a perspective similar to the reader. This reading process begins to break down when larger groups of listeners are involved because the larger group of listeners can no longer see the book from the same perspective as the reader.

Educators, child care providers, family members and other individuals that commonly read aloud to others are often required to read to larger groups of individuals. As seen above, side-by-side or individualized reading is not usually possible for larger groups or in situations where the listener is facing the reader. When reading to a group of listeners from a standard book the reader usually sits or stands facing the group of listeners. The standard book must be facing the one or more listeners in order for the one or more listeners to view the pages of the book and follow along with the reader. This presents a problem because it is generally not feasible for the reader to read the text at the same time the listeners see the pages of the standard book.

Several techniques have been developed to work around this problem. In a first solution, a reader may show the one or more listeners a relevant page of the standard book The reader may then turn the entire book towards the reader so that the reader may read the text aloud. When the reader is finished with the relevant page, the entire book may again be turned back towards the one or more listeners so that the listeners can associate the materials that were read with the relevant page of the book While this process allows for both reading by the reader and viewing by the one or more listeners, the process can be highly inefficient. The listeners may not be able to see the relevant page of the book while the reader is reading. Furthermore, the repeated turning of the book may be distracting to the one or more listeners and may reduce listening comprehension and appreciation of the reading materials.

Another solution to the problem may be for the reader to hold the book at an angle that allows the reader to see the text of the relevant page while the one or more listeners can also see the relevant page of the book This solution often involves holding the book at an awkward angle for the reader, i.e. generally either off to the side of the reader or below the face of the reader. The angle of the book in relation to the reader may make reading the relevant page difficult because the reader is either reading at an extreme angle or upside down. Furthermore, holding the book to the side may also be uncomfortable for the reader and/or require frequent adjustments of the book that distract the one or more listeners.

Other existing solutions may involve creation of new types of books that can be read to larger groups. For example, books have been designed with a first set of text on a first page of the book and a substantially similar second set of text on a corresponding, adjacent second page of the book. The book may have a spiral binding that allows the pages to be rotated so that the first page faces the one or more listeners while the second page faces the reader. The pages of the book are flipped in a predetermined sequence such that corresponding, substantially similar text and illustrations are always viewable by the reader and the one or more listeners at the same time. These modified books function for reading to groups, but are not easily used for standard reading. Moreover, these types of books require special manufacturing that greatly increases cost and complexity. Furthermore, these books do not encourage interactive reading processes through prompts or suggested interactive concepts.

Interactive reading may be generally defined as a strategy used by readers to engage listeners in the reading process. The primary objective of an interactive reading strategy may be contextualized language, while a secondary objective may be active involvement of a learner.

Generally, educators agree that readers should read aloud to listeners on a regular basis. Expert readers may often model fluency and stop periodically to ask questions. Non-expert readers generally demonstrate some interactive reading attributes, but there may often be a potential for improvement.

There are many benefits of interactive reading processes, including introducing listeners to the joy of reading. The more listeners read the better readers they become. Effective interactive learning experiences contribute to literacy development by exposing listeners to the power of language. Interactive reading can introduce new vocabulary, concepts, and text structures in context. Listeners may move from hearing to reading to telling stories, using the literary patterns demonstrated in interactive learning processes.

Generally, needs exist for improved apparatus and methods for interactive reading. More specifically, needs exist for a book attachment that allows a book to be easily read aloud to one or more listeners in an interactive reading process, while still being able to easily function as a standard book when not being read aloud to one or more listeners.

### SUMMARY OF THE INVENTION

Embodiments of the present invention solve many of the problems and/or overcome many of the drawbacks and disadvantages of the prior art by providing an apparatus and method for interactive reading that allows a standard book to be comfortably and efficiently read to one or more listeners without hindering the standard use of the book.

In particular, embodiments of the invention may accomplish this with an apparatus for facilitating reading aloud to one or more listeners. The apparatus may have one or more attachment covers, one or more couplings on at least one of the one or more attachment covers adapted to couple the apparatus to one or more book covers of a book, a binding attached to the one or more attachment covers, one or more attachment pages attached to the binding, and reading material on the one or more attachment pages substantially corresponding to reading material on one or more book pages in the book.

Preferably, the apparatus may have a first attachment cover with a first coupling and a second attachment cover with a second coupling. The first coupling may couple the first attachment cover to a first cover of the book and the second coupling may couple the second attachment cover to a second cover of the book.

The one or more couplings maybe selected from the group consisting of pockets, folds, flaps, tabs, straps, and combinations thereof. The binding maybe a spiral binding.

The reading material maybe text and images. The reading material on each of the attachment pages substantially corresponds to reading materials on two or more book pages. Prompts on the one or more attachment pages may relate to the reading materials. The prompts maybe selected from the group consisting of potential discussion topics, cues for the reader, questions for the one or more listeners, additional facts or information not found in the reading material, lesson materials, and combinations thereof.

The attachment may be removably coupled to the one or more book covers of the book.

Additional reading material maybe located on at least one of the one or more couplings.

Embodiments of the present invention may also include a method of reading aloud to one or more listeners from a book An apparatus as described above may be provided. The apparatus may then be coupled to a book. The reader may then hold the combined apparatus and book where the apparatus substantially faces a reader and the book substantially faces one or more listeners, read aloud the reading materials on the one or more apparatus pages, advance the one or more apparatus pages, repeat the reading aloud and advancing steps for each apparatus page, and advance the one or more book pages so that the reading material on the one or more apparatus pages being read aloud corresponds to the reading material on the one or more book pages. The apparatus may be uncoupled from the book

Additional reading material maybe found on the one or more couplings. The reader may read aloud the additional reading material on the one or more couplings before or after reading aloud the reading material on the one or more apparatus pages.

Prompts may be located on the one or more attachment pages corresponding to the reading materials on the one or more attachment pages. The prompts maybe utilized to develop activities and questions related to the reading material on the one or more attachment pages.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE INVENTION

The accompanying drawings, which are included to provide a further understanding of the invention and are incorporated in and constitute a part of this specification, illustrate preferred embodiments of the invention and together with the detailed description serve to explain the principles of the invention. In the drawings:

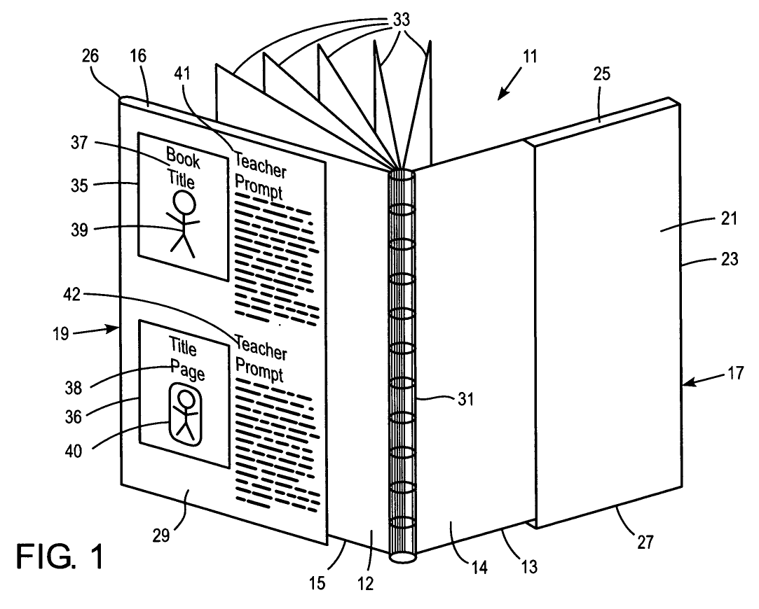

FIG. 1 is a perspective view of an embodiment of a book attachment.

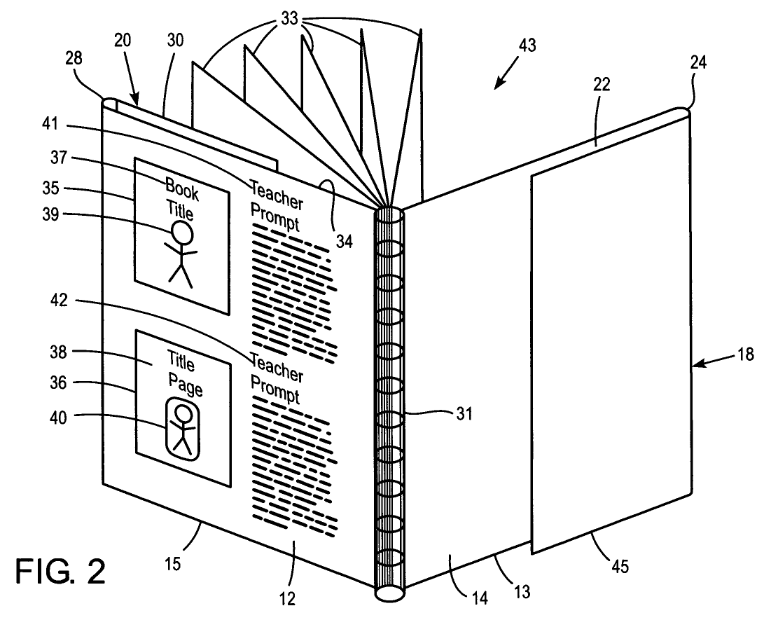

FIG. 2 is a perspective view of an alternative embodiment of a book attachment.

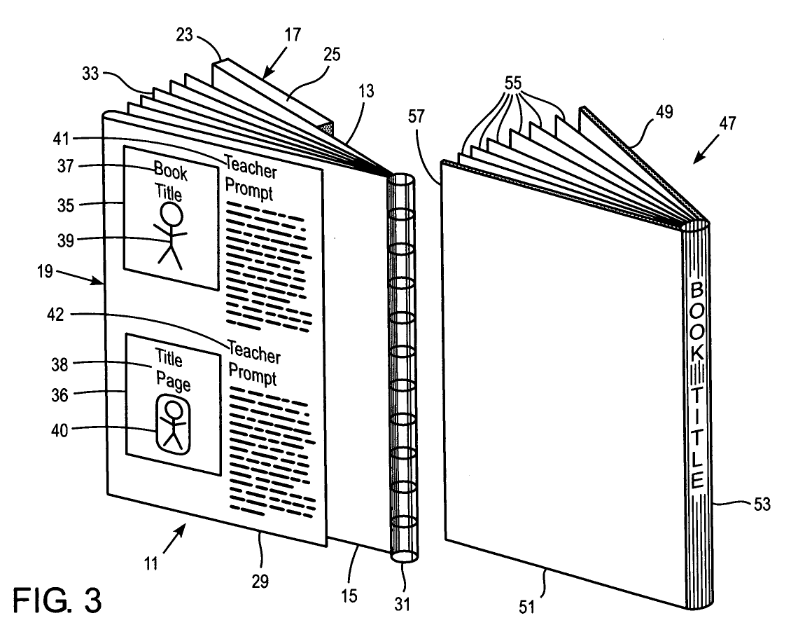

FIG. 3 is a perspective view of the book attachment of FIG. 1 prior to insertion of a book.

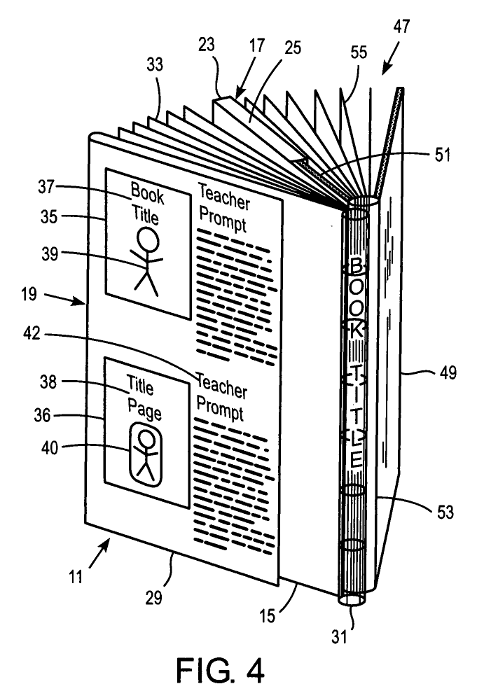

FIG. 4 is a perspective view of the combined book and book attachment of FIG. 1 from the reader's perspective for reading the cover.

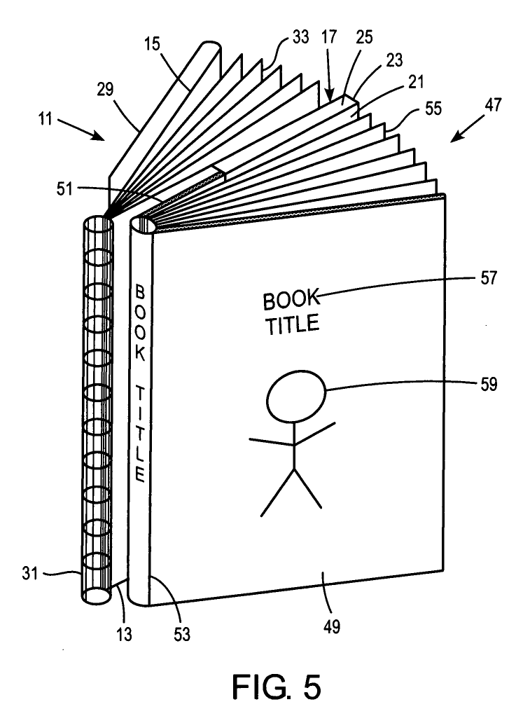

FIG. 5 is a perspective view of the combined book and book attachment of FIG. 1 from the listener's perspective for viewing the cover.

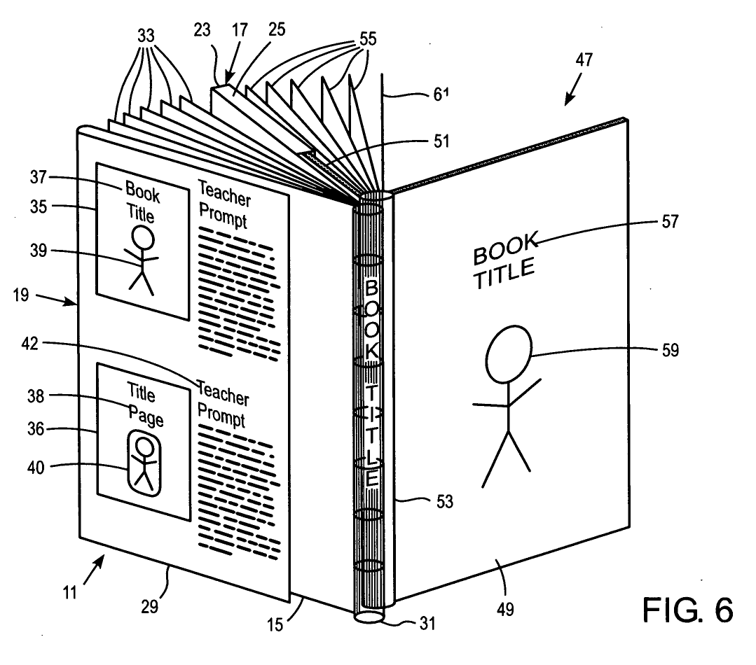

FIG. 6 is a perspective view of the combined book and book attachment of FIG. 1 from the reader's perspective for reading the title page.

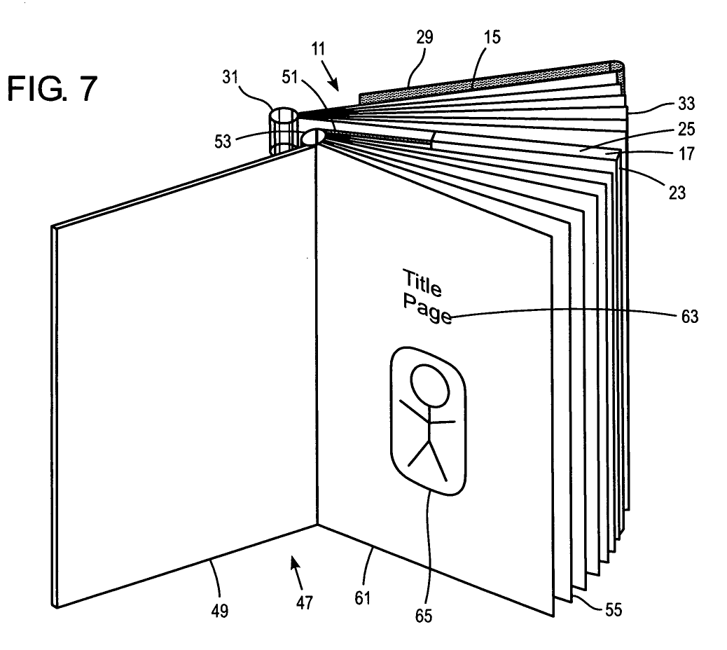

FIG. 7 is a perspective view of the combined book and book attachment of FIG. 1 from the listener's perspective for viewing the title page.

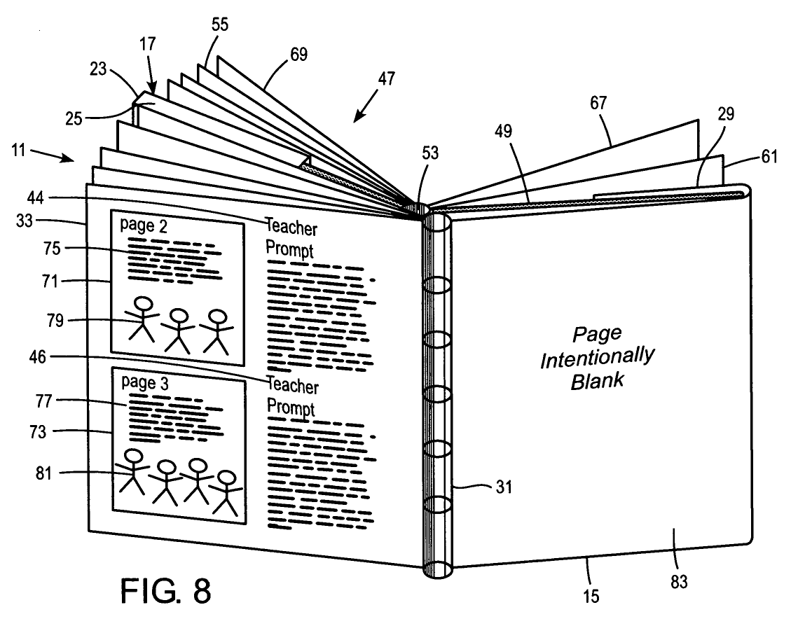

FIG. 8 is a perspective view of the combined book and book attachment of FIG. 1 from the reader's perspective for reading pages 2 and 3.

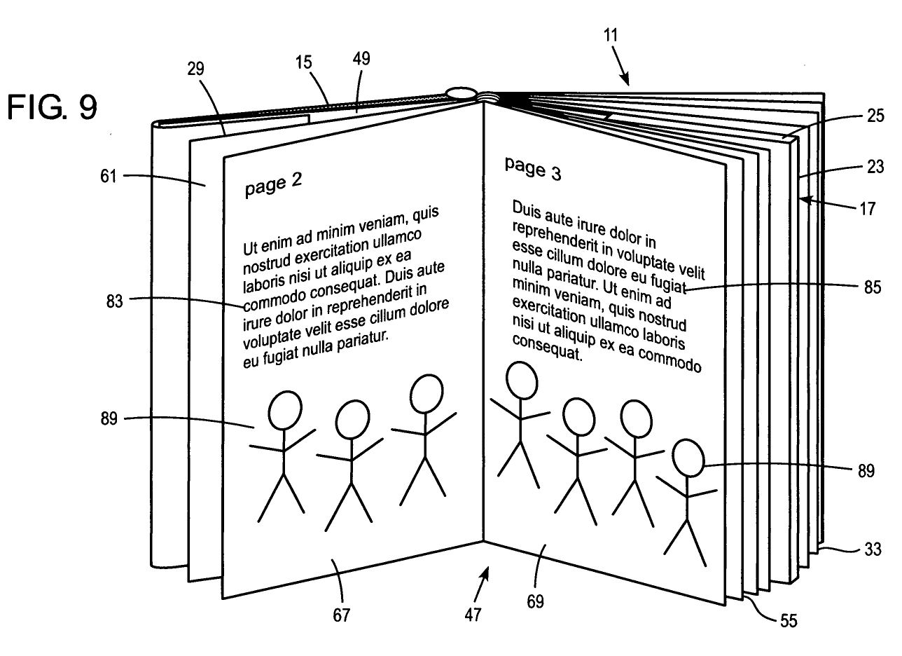

FIG. 9 is a perspective view of the combined book and book attachment of FIG. 1 from the listener's perspective for viewing pages 2 and 3.

### DETAILED DESCRIPTION OF THE PREFERRED EMBODIMENTS

Embodiments of the present invention may include an attachment for use in an interactive reading method. The attachment may be coupled to one or more covers of a standard book for allowing a reader to read the book to one or more listeners while facing the one or more listeners without excessive movement of the book The interactive reading method may use interactive prompts and suggested activities printed in the attachment to actively engage the one or more listeners in the reading process.

FIG. 1 is a perspective view of an embodiment of a book attachment 11. The book attachment 11 may have one or more covers 13, 15. The book attachment 11 may have a front cover 13 and a back cover 15. One or both of the covers 13, 15 may have a coupling. Preferably, the book attachment 11 has a front coupling 17 on the front cover 13 and a back coupling 19 on the back cover 15.

The front coupling 17 on the front cover 13 maybe a pocket for receiving a cover of a book as shown in FIG. 1. Other couplings devices are possible, such as folds, flaps, tabs, straps, etc. A pocket-shaped front coupling 17 may have a front surface 21, an end surface 23, a top surface 25, and a bottom surface 27. A back cover of a standard book may be inserted into the front coupling 17. The back cover of a standard book may be inserted into the front coupling 17 such that the outer surface of the back cover of the standard book contacts a front surface 14 of the front cover 13. The back cover of a standard book may slide into the pocket-shaped front coupling 17 until an end of the back cover of the standard book contacts the end surface 23 of the front coupling 17. The front surface 21, top surface 25 and bottom surface 27 of the front coupling 17 may prevent the sliding or other unwanted movement of the book relative to the book attachment 11.

The back coupling 19 on the back cover 15 may be a flap 29 for wrapping around a cover of a book. Preferably, the back coupling 19 may wrap around a front cover of a standard book The flap 29 may be rotated around a hinge 26 away from a front surface 12 of the back cover 15 to allow a front cover of a standard book to pass the flap 29 and abuts against the front surface 12 of the back cover 15. The flap 29 may then be rotated around the hinge 26 back towards the front cover of the standard book until the flap 29 abuts against the front cover of the standard book. Therefore, the front cover of the standard book may reside within a gap 16 between the flap 29 and the front surface 12 of the back cover 15. Preferably, the front cover of the standard book is aligned so that an end of the front cover abuts the hinge 26. The flap 29 may further couple the front cover of a standard book to the back coupling 19 to prevent unwanted movement of the book relative to the book attachment 11.

The front cover 13 of the book attachment 11 maybe connected to the back cover 15 of the book attachment 11 with a binding 31. The binding 31 may be a spiral or other type of binding that allows for rotation of the covers 13, 15. The binding 31 may also be connected to one or more pages 33 of the book attachment 11. The book attachment 11 may contain as many pages 33 as needed to describe the contents of the book. The pages 33 may contain text and/or illustrations that substantially correspond to the text and/or illustrations in the standard book The binding 31 may hold the covers 13, 15 and the pages 33 in relative positions so that a reader may flip through the pages 33 while reading the book aloud to one or more listeners.

In addition to text and/or illustrations on the pages 33 of the book attachment 11, the flap 29 of the back coupling 19 of the book attachment 11 may contain reproductions 35,36 of text 37, 38 and illustrations 39, 40 found on the cover and/or title page of a corresponding standard book Alternatively, the flap 29 may contain reproductions of only one of the cover and/or title page of a corresponding standard book The flap 29 of the back coupling 19 of the book attachment 11 may also contain teacher prompts 41, 42 and other materials for enhancing the reading experience with the interactive reading process described below. The teacher prompts 41, 42 preferably correspond to the contents of each page of a standard book Teacher prompts 41, 42 are described in more detail below.

FIG. 2 is a perspective view of an alternative embodiment of a book attachment 43. The book attachment 43 may have one or more covers 13, 15. Preferably, the book attachment 43 may have a front cover 13 and a back cover 15. One or both of the covers 13, 15 may have couplings 18, 20. The front cover 13 may have a front coupling 18 and the back cover 15 may have a back coupling 20.

The front coupling 18 maybe a first flap 45 for receiving a first cover of a standard book To couple the book attachment 43 to a standard book the first flap 45 may be rotated around a hinge 24 away from a front surface 14 of the front cover 13 of the book attachment 43. A first cover of a standard book may pass into a gap 22 between the first flap 45 and the front surface 14 of the front cover 13 of the book attachment 43 until an outer surface of the first cover of the standard book abuts the front surface 14 of the front cover of the book attachment 43. The first flap 45 may then be rotated around the hinge 24 until the first flap 45 abuts an inner surface of the first cover of a standard book. Preferably, the front cover of the standard book is aligned so that an end of the front cover abuts the hinge 24. The front coupling 18 may couple the first cover of a standard book to the front coupling 18 of the book attachment 43 to prevent unwanted movement of the book relative to the book attachment 43.

The front cover 13 of the book attachment 43 may be connected to the back cover 15 of the book attachment 43 with a binding 31. The binding 31 may be a spiral or other type of binding that allows for rotation of the covers 13, 15. The binding 31 may also be connected to one or more pages 33 of the book attachment 43. The book attachment 43 may contain as many pages 33 as needed to describe the contents of the book The pages 33 may contain text and/or illustrations that substantially correspond to the text and/or illustrations in the standard book. The binding 31 may hold the covers 13, 15 and the pages 33 in relative positions so that a reader may flip through the pages 33 while reading the book aloud to one or more listeners.

In addition to text and/or illustrations on the pages 33 of the book attachment 11, a front surface 12 of the back cover 15 of the book attachment 43 may contain reproductions 35, 36 of text 37, 38 and illustrations 39, 40 found on the cover and/or title page of a corresponding standard book. Alternatively, the front surface 12 of the back cover 15 of the book attachment 43 may contain reproductions of only one of the cover and/or title page of a corresponding standard book The front surface 12 of the back cover 15 of the book attachment 43 may also contain teacher prompts 41, 42 and other materials for enhancing the reading experience with the interactive reading process described below. The teacher prompts 41, 42 preferably correspond to the contents of each page of a standard book Teacher prompts 41, 42 are described in more detail below.

The back coupling 20 on the back cover 15 of the book attachment 43 may be a second flap 30 for wrapping around a second cover of a standard book The second flap 30 may reside folded against a back surface 34 of the back cover 15 of the book attachment 11 during reading of the reproductions 35, 36 of text 37, 38 and illustrations 39, 40 found on the cover and/or title page. Once the reading of the reproductions 35, 36 of text 37, 38 and illustrations 39, 40 found on the cover and/or title page is completed, the book attachment 43 may be further coupled to the standard book by rotating the back cover 15 around the binding 31.

To further couple the book attachment 43 to a standard book, the second flap 30 may be rotated around a hinge 28 away from a back surface 34 of the back cover 15 of the book attachment 43. An outer surface of a second cover of a standard book may abut the front surface 12 of the back cover 15 of the book attachment 43. The second flap 30 maybe further rotated around the hinge 28 until the second flap 30 abuts an inner surface of a second cover of a standard book. The second cover of the standard book may be aligned so that an end of the second cover abuts the hinge 28. The back coupling 20 may couple the second cover of a standard book to the back coupling 20 of the book attachment 43 to prevent unwanted movement of the book relative to the book attachment 43.

The front cover 13 maybe connected to the back cover 15 with a binding 31. The binding 31 maybe a spiral or other type of binding that allows for rotation of the covers 13, 15 and pages 33 of a book The attachment 43 may contain as many pages 33 as needed to describe the contents of the book The binding 31 holds the covers 13, 15 and the pages 33 so that a reader may flip through the pages 33 while reading the book to one or more listeners.

To use the book attachment 43 of FIG. 2, the book attachment 43 may be coupled to the standard book with the first coupling 18 as described above. The book attachment 43 may be aligned with the standard book such that the reader preferably sees primarily the book attachment 43, and the listener preferably sees primarily the book A front cover of the book may be shown to the listeners while the reader views the back cover 15 of the book attachment 43. The reader then reads the reproductions 35, 36 of text 37, 38 and illustrations 39, 40 corresponding to the cover and/or title pages of the book. The reader may also utilize any prompts 41, 42 corresponding to the reproductions 35, 36.

Once completed with the reproductions 35, 36 and prompts 41, 42, the reader further couples the book attachment 43 to the standard book with the second coupling 20 as described above. Coupling the second coupling 20 to a book cover reveals a first page 33 of the book attachment 43. The reader may then read the contents of the first page 33 of the book attachment 43 to the one or more listeners. The reader preferably flips pages in the standard book at appropriate times during reading from the pages 33 of the book attachment 43. Reading aloud may continue with the reader viewing reproductions of text and/or illustrations on pages 33 of the book attachment 43, while the listener sees the corresponding pages of the book Reading aloud maybe completed when the end of the book is reached.

FIG. 3 is a perspective view of the book attachment 11 of FIG. 1 prior to insertion of a book 47 into the first coupling 17. FIG. 3 and the following figures use the exemplary embodiment of the book attachment 11 from FIG. 1 for illustrative purposes. However, similar methods maybe used with alternative embodiments.

A book 47 preferably has a front cover 49, back cover 51, spine 53 and one or more pages 55. The book 47 may be hardcover or paperback but stiffer covers are preferred for more stable coupling to the book attachment 11. To couple the book attachment 11 with the book 47, the back cover 51 of the book 47 may aligned with the front coupling 17 of the book attachment 11 such top and bottom surfaces of the book 47 align with top and bottom surfaces of the book attachment 11. The back cover 51 of the book 47 and front coupling 17 of the book attachment 11 may slide together until an edge 57 of the back cover 51 contacts an inside of the end surface 23 of the book attachment 11. The book attachment 11 is preferably sized such that the back cover 51 of the book 47 has similar dimensions to the front cover 13 of the book attachment 11. The coupling of the book attachment 11 to the book 47 may prevent unwanted relative movement of the book attachment 11 and the book 47.

FIG. 4 is a perspective view of the combined book 47 and book attachment 11 from the reader's perspective for reading the front cover 49 of the book 47. Preferably, the spine 31 of the book attachment 11 aligns with the spine 53 of the book 47 such that the pages 33 of the book attachment 11 maybe freely rotated around the spine 31 to come into alignment with the front cover 49 of the book 47. When the book attachment 11 and book 47 are initially coupled, the reader sees the flap 29 with reproductions 35, 36 of text 37, 38 and illustrations 39, 40 found on the cover and/or title page of a standard book The reader may also see the any teacher prompts 41, 42 and other materials included on the flap 29. Preferably, the flap 29 may contain reproductions 35, 36 of text 37, 38 and illustrations 39, 40 for multiple pages 33 at once. For example, FIG. 4 shows reproductions 35 for a cover and a title page.

FIG. 5 is a perspective view of the combined book 47 and book attachment 11 from the listener's perspective for viewing the cover 49 of the book 47. The book attachment 11 is preferably minimally viewable by the listener. Therefore, the reader may primarily see the book attachment 11, while the reader may primarily see the cover 49 of the book 47. The cover 49 of the book 47 preferably has text 57 and/or illustrations 59 corresponding to the reproductions 35 of text 37 and/or illustrations 39 on the flap 29. The reader may proceed to read aloud the reproductions 35 of text 37 and illustrations 39 for the front cover 49 of the book 47 corresponding to the text 57 and illustrations 59 on the front cover 49 of the book 47. The reader may also utilize any prompts 41 corresponding to the front cover 49 of the book 47. The reader may then open the front cover 49 of the book 47 to reveal a title page 61 of the book 47.

FIG. 6 is a perspective view of the combined book 47 and book attachment 11 from the reader's perspective for reading a title page 61 of the book 47. After finishing reading the reproductions 35 of the text 37 and/or illustrations 39, and any prompts 41 related to the front cover 49 of the book 47, the reader may reach around to the front of the book 47 and open the front cover 49 to reveal the title page 61. Preferably, the reader does not have to turn the book 47 around during opening of the front cover 49, and the book 47 continually faces the one or more listeners. Since the flap 29 is printed with reproductions 35, 36 of text 37, 38 and/or illustrations 39, 40 of both the cover 49 and title page 61 the reader does not need to move any parts of the book attachment 11 at this time.

FIG. 7 is a perspective view of the combined book 47 and book attachment 11 from the listener's perspective for viewing the title page. As before, the book attachment 11 is preferably minimally viewable by the listener. Therefore, the reader may primarily see the book attachment 11, while the reader may primarily see the title page 61 of the book 47. The reader proceeds to read aloud the reproductions 36 of the text 38 and/or illustrations 40 correlating to the text 63 and/or illustrations 65 on the title page 61. The reader may also use any prompts 42 corresponding to the title page 61.

FIG. 8 is a perspective view of the combined book 47 and book attachment 11 from the reader's perspective for reading page two 67 and page three 69. As indicated previously, it is preferable to include reproductions 71, 73 of text 75, 77 and/or illustrations 79, 81 of two or more pages for each page 33 of the book attachment 11 and/or prompts 44, 46. Other configurations are possible. Backsides 83 of pages 33 are preferably intentionally left blank but may also contain reproductions of text and/or illustrations and/or prompts correlating to pages 55 of the book 47.

After finishing reading the reproductions 36 of the title page 61 and any prompts 42 related to the title page 61, the reader may reach around to the front of the book 47 and flip the cover page 61 to reveal page two 67 and page three 69 of the book 47 to the one or more listeners. Preferably, the reader does not have to turn the book 47 around during the cover opening and the book 47 continually faces the one or more listeners.

The reader preferably now advances the book attachment 11 as described above. The back cover 15 of the book attachment 11 may be rotated around the spine 31 of the book attachment 11 until the back cover 15 contacts the front cover 49 of the book 47. The flap 29 may then be wrapped around the front cover 49 of the book 11 such that the flap 29 rests between the front cover 49 and the title page 61. The wrapping of the flap 29 further secures the book attachment 11 to the book 47 to prevented unwanted relative movement of the book attachment 11 and the book 47. The movement and wrapping of the back cover 15 of the book attachment 11 preferably reveals a first page 33 of the book attachment 11. The reader may proceed to read the reproductions 71 of text 75 and/or illustrations 79 correlating to the text 83 and/or illustrations 87 on page two 67 of the book 47. The reader may also use any prompts 44 corresponding to page two 67 of the book The reader may then proceed to read the reproductions 73 of text 77 and/or illustrations 81 correlating to the text 85 and/or illustrations 89 on page three 69 of the book 47. The reader may also use any prompts 46 corresponding to page three 69 of the book 47.

FIG. 9 is a perspective view of the combined book 47 and book attachment 11 from the listener's perspective for viewing page two 67 and page three 69 of the book 47. As before, the book attachment 11 is preferably minimally viewable by the listener. Therefore, the reader may primarily see the book attachment 11, while the reader may primarily see page two 67 and page three 69 of the book 47.

Once the reader has finished reading aloud the reproductions 73 of the text 77 and/or illustrations 81 and/or prompts 46 for page three 69 of the book 47 the pages 33 of the book attachment 11 and the pages 55 of the book 47 may be flipped. The reader may flip either the pages 33 of the book attachment 11 or the pages 55 of the book 47 first. Page flipping reveals the next sequential pages 33, 55. The reading aloud and page flipping process is repeated as described above until the end of the book 47 is reached.

The prompts 41, 42, 44, 46 maybe part of an interactive method of reading. Interactive reading may improve attention to and comprehension of the material being read. The prompts 41, 42, 44, 46 may include potential discussion topics, cues for the reader, questions for the listeners, additional facts or information not found in the text and/or illustrations, and other lesson materials. The prompts 41, 42, 44, 46 may be used by readers to expand the reading and listening experience. The prompts 41, 42, 44, 46 maybe optional for the reader, with the reader determining whether to utilize the prompts in different situations and with different listeners.

The prompts 41, 42, 44, 46 maybe incorporated into the interactive reading method of the present invention. The prompts 41, 42, 44, 46 may allow a reader to involve the one or more listeners in the interactive reading processes. Interactive reading processes may include, but are not limited to, using questions, inviting the one or more listeners to mime active verbs, repeating key phrases as a chorus, discussing details in the illustrations, identifying characters and settings, predicting of what may happen next in the story, introducing new vocabulary, concepts, and text structures in context, and other processes.

The book attachment of the present invention may be used with any standard book The book attachment may be sold separately and purchased by readers for only the books desired. The book attachment maybe coupled and uncoupled to the book at anytime. Preferably, when the book attachment is not in use, the book attachment is uncoupled from the book When the book attachment is uncoupled, the standard book may be read as a standard book.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention maybe used in conjunction with other embodiments, even if not explicitly stated above.

What is claimed is:

1. An apparatus for facilitating reading aloud to one or more listeners comprising:
one or more attachment covers,
one or more couplings on at least one of the one or more attachment covers adapted to couple the apparatus to one or more book covers of a book,
a binding attached to the one or more attachment covers,
one or more attachment pages attached to the binding, and
reading material on the one or more attachment pages substantially corresponding to reading material on one or more book pages in the book.

2. The apparatus of claim 1, wherein the apparatus comprises a first attachment cover with a first coupling and a second attachment cover with a second coupling.

3. The apparatus of claim 2, wherein the first coupling couples the first attachment cover to a first cover of the book and the second coupling couples the second attachment cover to a second cover of the book.

4. The apparatus of claim 1, wherein the one or more couplings are selected from the group consisting of pockets, folds, flaps, tabs, straps, and combinations thereof.

5. The apparatus of claim 1, wherein the binding is a spiral binding.

6. The apparatus of claim 1, wherein the reading material is text and images.

7. The apparatus of claim 6, wherein the reading material on each of the attachment pages substantially corresponds to reading materials on two or more book pages.

8. The apparatus of claim 1, further comprising prompts relating to the reading materials on the one or more attachment pages.

9. The apparatus of claim 8, wherein the prompts are selected from the group consisting of potential discussion topics, cues for the reader, questions for the one or more listeners, additional facts or information not found in the reading material, lesson materials, and combinations thereof.

10. The apparatus of claim 1, wherein the attachment is removably coupled to the one or more book covers of the book.

11. The apparatus of claim 1, further comprising additional reading material on at least one of the one or more couplings.

12. An apparatus for facilitating reading aloud to one or more listeners comprising:
a binding coupling a front attachment cover to a back attachment cover,
a first coupling on the front attachment cover,
a second coupling on the back attachment cover,
one or more attachment pages coupled to the binding,
reading material on the one or more attachment pages substantially corresponding to reading material on one or more book pages in a book, and
wherein the first coupling is adapted to removably couple the front attachment cover to a first book cover and the second coupling is adapted to removably couple the back attachment cover to a second book cover.

13. A method of reading aloud to one or more listeners from a book comprising:
providing an apparatus comprising:
one or more attachment covers,
one or more couplings on at least one of the one or more attachment covers,
a binding attached to the one or more attachment covers,
one or more attachment pages attached to the binding, and
reading material on the one or more attachment pages substantially corresponding to reading material on one or more book pages in the book,
coupling the apparatus to a book,
holding the combined apparatus and book where the apparatus substantially faces a reader and the book substantially faces one or more listeners,
reading aloud the reading materials on the one or more apparatus pages,
advancing the one or more apparatus pages,
repeating the reading aloud and advancing steps for each apparatus page, and
advancing the one or more book pages so that the reading material on the one or more apparatus pages being read aloud corresponds to the reading material on the one or more book pages.

14. The method of claim 13, further comprising uncoupling the apparatus from the book.

15. The method of claim 13, wherein the apparatus further comprises additional reading material on the one or more couplings.

16. The method of claim 15, further comprising reading aloud the additional reading material on the one or more couplings before or after reading aloud the reading material on the one or more apparatus pages.

17. The method of claim 13, wherein the apparatus further comprises prompts on the one or more attachment pages corresponding to the reading materials on the one or more attachment pages.

18. The method of claim 17, wherein the prompts are selected from the group consisting of potential discussion topics, cues for the reader, questions for the one or more listeners, additional facts or information not found in the reading material, lesson materials, and combinations thereof.

19. The method of claim 18, further comprising utilizing the prompts to develop activities and questions related to the reading material on the one or more attachment pages.

20. The method of claim 13, wherein a first coupling couples a first attachment cover to a first cover of the book and a second coupling couples a second attachment cover to a second cover of the book.
